(19) United States
(12) Patent Application Publication
(10) Pub. No.: US 2025/0272605 A1
(43) Pub. Date: Aug. 28, 2025

(54) EFFICIENT NORMALIZATION OPERATIONS IN MACHINE LEARNING MODELS

(71) Applicant: QUALCOMM Incorporated, San Diego, CA (US)

(72) Inventors: Haoping XU, North York (CA); Prajakt KULKARNI, San Diego, CA (US); Suze BALATSOS, Markham (CA); Sachin Raghunath ABDAGIRE, San Diego, CA (US); Nikolina ASKOVIC, Toronto (CA); Anam ZAIN, Burlington (CA); Shiqi SUN, Newmarket (CA); Nanda Kumar ASWATHA KUMAR, North York (CA); Neelkanth Pradhumanbhai PATEL, Scarborough (CA); Sheng ZHAN, Richmond Hill (CA); Shaojie ZHUO, Richmond Hill (CA)

(21) Appl. No.: 18/587,544

(22) Filed: Feb. 26, 2024

(51) Int. Cl. G06N 20/00

(52) U.S. Cl. CPC G06N 20/00

(57) ABSTRACT

Certain aspects of the present disclosure provide techniques and apparatus for improved machine learning. In an example method, an input tensor comprising a plurality of segments is accessed, the input tensor generated while processing data using a machine learning model. A normalization operation of the machine learning model is applied to the input tensor by generating a mean value for a segment of the input tensor, generating an intermediate segment based on differences between the mean value and each element of the segment, generating a normalization scaling factor for the segment based on the intermediate segment, generating a scaled segment based on scaling each element of the intermediate segment using the normalization scaling factor, and generating a normalized output tensor based on at least the scaled segment.

### INTRODUCTION

Aspects of the present disclosure relate to machine learning.

A wide variety of machine learning models have been trained for a similarly vast assortment of tasks in recent years. A similarly vast assortment of machine learning architectures have similarly been used to perform various tasks. For example, neural networks have been trained to perform tasks such as computer vision tasks, time series analysis, speech recognition, and the like. Often, machine learning models (such as neural networks) use a variety of normalization operations to transform feature tensors such that these tensors have a similar scale, which can improve training stability and inference accuracy. Various normalization operations have been used, including batch normalization (which seeks to control the feature's mean and variance across batches or mini-batches) and layer normalization (which generally normalizes the distribution of intermediate layers in the network). For example, transformer-based networks are often heavily reliant on layer normalization at multiple points in the data flow. However, such normalization operations are often computationally complex and expensive.

### BRIEF SUMMARY

Certain aspects of the present disclosure provide a method for machine learning using a processor (e.g., a processor-implemented method), comprising: accessing an input tensor comprising a plurality of segments, the input tensor generated while processing data using a machine learning model; and applying a normalization operation of the machine learning model to the input tensor, comprising: generating a first mean value for a first segment of the input tensor; generating a first intermediate segment based on differences between the first mean value and each element of the first segment; generating a first normalization scaling factor for the first segment based on the first intermediate segment; generating a first scaled segment based on scaling each element of the first intermediate segment using the first normalization scaling factor; and generating a normalized output tensor based on at least the first scaled segment.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example architecture for improved data normalization for machine learning, according to some aspects of the present disclosure.

FIGS. 2A and 2B depict example workflows for pipelined normalization for machine learning, according to some aspects of the present disclosure.

FIG. 3 is a flow diagram depicting an example method for improved data normalization for machine learning, according to some aspects of the present disclosure.

FIG. 4 is a flow diagram depicting an example method for efficient normalization scaling factor generation for improved normalization for machine learning, according to some aspects of the present disclosure.

FIG. 5 is a flow diagram depicting an example method for normalization operations in machine learning models, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

As discussed above, normalization operations (such as layer normalization and/or batch normalization) are often used in machine learning models, such as in neural networks and other transformer-based models, to normalize feature tensors during runtime (e.g., during training and/or inferencing). However, in some conventional architectures, such normalization operations are computationally expensive. For example, in some conventional systems, layer normalization operations are computed using four separate data accesses (e.g., to off-die memory), which are each slow and expensive: a first step to scan the whole input data (e.g., the feature tensor) and generate a mean value, a second step to generate the variance based on the mean value, a third step to generate a normalization scale factor based on the variance, and a fourth step to apply the normalization scaling (as well as batch normalization in some aspects).

These repeated accesses in some conventional systems rely on high bandwidth for data transfer and introduce substantial computational cost and latency. Further exacerbating the concerns, layer normalization is performed individually for each individual segment of the feature tensor (e.g., for each row or slice), meaning that the repeated data accessing and processing is generally performed four times per segment. As feature tensors can have hundreds of such segments, each layer normalization operation in some conventional architectures (which often include many hundreds of applications of the layer normalization) results in substantial cost and delay.

In many systems, a variety of hardware accelerators or specialized processing units (e.g., neural processing units (NPUs), tensor processing units (TPUs), and the like) can be used to perform some or all of the operations involved in machine learning. For example, some NPUs provide two datapaths: an elementwise datapath for performing elementwise operations such as addition and multiplication, as well as a matrix datapath (e.g., a multiply-accumulate (MAC) component) for performing matrix operations such as convolution or general matrix multiplication (GEMM). Some NPUs further provide a post-processing unit (after the elementwise and matrix datapaths) to perform operations such as activation, quantization, batch normalization, and the like.

In some conventional architectures, such NPUs are often used multiple times (e.g., using four iterations of processing data using one NPU, using four NPUs, and/or using four nodes or layers of an NPU) to perform layer normalization, where each iteration relies on accessing data from off-die memory, and storing output in off-die memory. In some aspects of the present disclosure, additional pre-processing and post-processing logic is introduced to enable a single processing unit layer (e.g., an NPU) to perform multiple portions of the layer normalization operation in one iteration. For example, the architecture and techniques described herein may enable the system to generate the normalization scale factor for a given segment using a single cycle or iteration of the processing unit (e.g., replacing three separate cycles used in some conventional approaches), followed by a second cycle or iteration to actually apply the normalization. This may reduce the overall data bandwidth substantially (e.g., reducing the memory accesses by two-thirds) while also reducing the processing time (e.g., reducing the number of cycles used by two-thirds).

In some aspects, multiple tensor segments can further be pipelined in the processing unit, further reducing the latency (e.g., by another one-half). In some aspects, by using the pre-processing and post-processing operations of the present disclosure, the bandwidth used by layer normalization operations is reduced by two-thirds, and the performance is increased by six times (e.g., by using fewer cycles).

### Example Architecture for Improved Data Normalization for Machine Learning

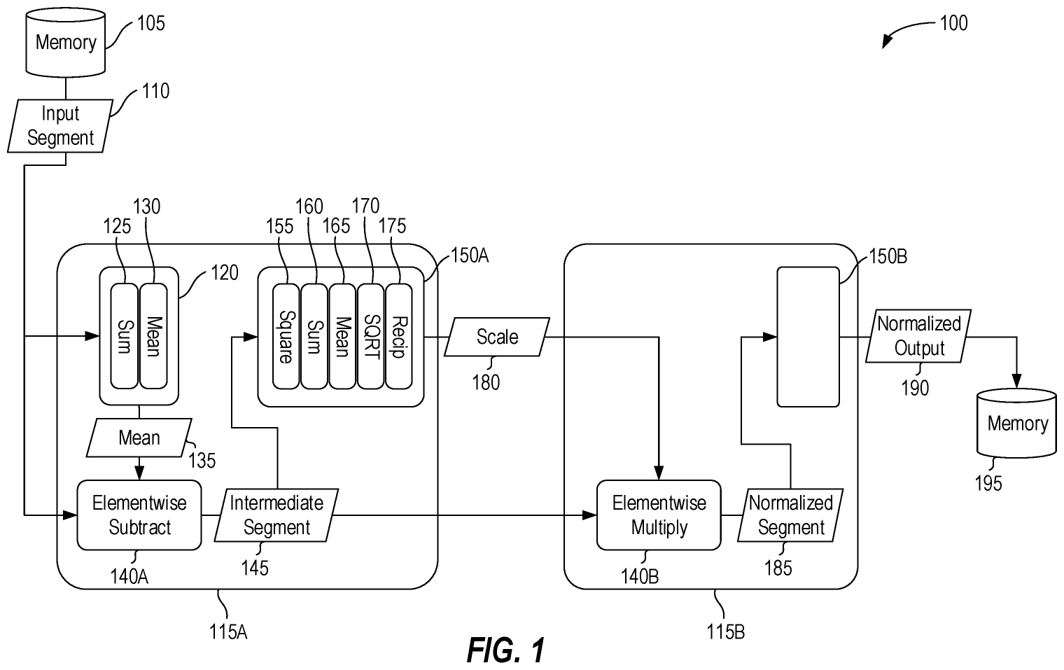

FIG. 1 depicts an example architecture 100 for improved data normalization for machine learning, according to some aspects of the present disclosure. In some aspects, the architecture 100 is used by a computing system to perform a layer normalization operation (e.g., as part of processing data using a machine learning model during training and/or inferencing).

As illustrated, an input segment 110 is accessed from a memory 105. As used herein, “accessing” data can generally include receiving, requesting, retrieving, obtaining, or otherwise gaining access to the data. The input segment 110 is generally representative of a portion of an input tensor, such as a feature tensor generated while processing data using a machine learning model (e.g., a transformer-based neural network). In some aspects, for example, the feature tensor may comprise activation data (e.g., generated by processing a tensor using an activation function) from a prior layer or operation of the machine learning model.

The input segment 110 may represent any portion of the feature tensor. For example, the input segment 110 may correspond to a row of the feature tensor, a slice of the feature tensor, and the like. The memory 105 is generally representative of any off-die memory. As used here, memory or storage may be referred to as “off-die” or “off-chip” to indicate that the memory or storage is on a separate die or chip from the processor (e.g., an NPU, such as represented by the processors 115A-B). For example, the memory 105 may correspond to dynamic random-access memory (DRAM).

Generally, accessing data (by a processor) from an off-die memory (such as the memory 105) is more computationally expensive (e.g., slower), as compared to accessing data from on-die memory or storage. As used herein, “on-die” or “on-chip” memory or storage may be used to indicate memory or storage that is on the same die or chip as the processor. For example, the on-die memory may correspond to static random-access memory (SRAM), such as tightly coupled memory (TCM), a processor cache, and the like. Generally, accessing data from on-die memory can be substantially less computationally expensive, though the on-die memory is often limited in terms of capacity.

In the illustrated example, the input segment 110 is accessed by a processor 115A. Although the illustrated example depicts two processors 115A and 115B for conceptual clarity, in some aspects, the processors 115A and 115B (collectively, the processor 115) may be implemented as two nodes or layers of a single processor 115, or as two iterations or cycles of processing data using a single processor 115 (e.g., where the processor 115A represents processing data using a single processor during a first iteration or cycle, and the processor 115B represents processing data using the same single processor during a second iteration or cycle). The processor 115 is generally representative of any computational processing unit that can be used to process data as discussed below, such as an NPU, a TPU, and the like.

In the illustrated example, the processor 115A includes a pre-processing module 120 (also referred to in some aspects as a pre-processing unit or component), an elementwise-processing module 140A (also referred to as an elementwise datapath, unit, or component in some aspects), and a post-processing module 150A (also referred to in some aspects as a post-processing unit or component). Although not pictured in the illustrated example, in some aspects, the processor 115A may further include a matrix datapath (e.g., a MAC), as discussed above. Further, although not depicted in the illustrated example, in some aspects, the processor 115A may include one or more control modules which control the flow of data through the processor 115A and/or control which operations are performed by each module (e.g., to steer input data to the matrix module or the elementwise-processing module 140A, to select whether output from the matrix module or the elementwise-processing module 140A is provided to the post-processing module 150A in any given cycle or iteration, and the like).

In some aspects, though some other processor architectures include components such as the elementwise-processing module 140A and the post-processing module 150A (and, in some aspects, a matrix datapath), the pre-processing module 120 may be an additional component of the processor 115A, not present in other processor architectures. Further, in some aspects, the particular operations performed by the post-processing module 150A may differ, as compared to other processor architectures.

In the illustrated architecture 100, the input segment 110 is accessed by the pre-processing module 120, which processes the input segment 110 to generate a mean 135 (also referred to in some aspects as the mean value) of the input segment 110. Specifically, in the illustrated example, the pre-processing module 120 includes a sum operation 125 which sums the elements of the input segment 110 and a mean operation 130 which divides the sum by the number of elements in the input segment 110 (or, equivalently, which multiplies the sum by the reciprocal of the number of elements). Although not included in the illustrated example, in some aspects, the mean 135 may be stored in a buffer upon being output by the pre-processing module (prior to being accessed by the elementwise-processing module 140A).

In the illustrated architecture 100, the input segment 110 is further accessed by the elementwise-processing module 140A. Although not included in the illustrated example, in some aspects, the input segment 110 may be stored in an on-die buffer or cache (e.g., SRAM) of the processor 115A prior to being accessed by the elementwise-processing module 140A (e.g., to store the input segment 110 until the pre-processing module 120 completes operations and outputs the mean 135).

In some aspects, the elementwise-processing module 140A performs a subtraction operation between the input segment 110 and the mean 135. That is, the elementwise-processing module 140A may subtract the mean 135 from each element in the input segment 110. The difference is output by the elementwise-processing module 140A as the intermediate segment 145. For example, if the input segment 110 is a tensor t_{0:I} having elements [0:I] and the mean 135 is m, the value of each element of the intermediate segment 145 may be defined as (tᵢ−m) for all i in [0:I].

In the illustrated example, the intermediate segment 145 is accessed by the post-processing module 150A, which processes the intermediate segment 145 to generate a scale 180 (also referred to as a normalization scale factor or value in some aspects). Specifically, in the illustrated example, the post-processing module 150A comprises a square operation 155, a sum operation 160, a mean operation 165, a square root operation 170, and a reciprocal operation 175.

In some aspects, the square operation 155 squares each element of the intermediate segment 145 to generate a squared segment. That is, if the intermediate segment 145 is a tensor s_{0:I} having elements [0:I], the value of each element of the squared segment may be defined as sᵢ² for all i in [0:I]. In some aspects, the sum operation 160 computes the sum of the elements of the squared segment. That is, the sum operation 160 may compute Σᵢ₌₀^{I}sᵢ². In some aspects, this sum may be referred to as a second sum or a squared sum (to differentiate this sum from the sum generated by the sum operation 125).

In some aspects, the mean operation 165 divides the second (or squared) sum by the number of elements in the squared segment (which may be equivalent to the number of elements in the intermediate segment 145 and the input segment 110). In some aspects, as discussed above, the mean operation 165 may equivalently multiply the second sum by the reciprocal of the number of elements). In some aspects, the output of the mean operation 165 may be referred to as a second mean or a squared mean (to differentiate this mean from the mean 135). In some aspects, the square root operation 170 computes the square root of the second mean to generate a square root value. The reciprocal operation 175 may then take the reciprocal of the square root value, and output this reciprocal as the scale 180.

In the illustrated architecture 100, if pipelining is used, the processor 115A may generate a mean 135, intermediate segment 145, and scale 180 during a single iteration or cycle (for three different input segments 110), as discussed in more detail below. For example, once an intermediate segment 145 is generated for an n-th segment and a mean 135 is generated for the (n−1)-th segment, the processor 115A may, in a single iteration, generate the scale 180 for the n-th segment (based on the intermediate segment 145 previously generated for the n-th segment) using the post-processing module 150A, generate an intermediate segment 145 for the n−1-th segment (based on the mean 135 previously generated for the (n−1)-th segment) using the elementwise-processing module 140A, and generate a mean 135 for a new input segment 110 (e.g., the (n−2)-th segment) using the pre-processing module 120.

During the subsequent iteration or cycle, each segment may move one step forward in the processor 115A, resulting in a new scale 180 being generated for a new segment each iteration (where the scale 180 for a given input segment 110 takes a total of three cycles or iterations to generate by the processor 115A).

In the illustrated architecture 100, the scale 180 and the intermediate segment 145 are accessed by a second processor 115B (e.g., a second layer or node of the processor, or the same processor during a subsequent iteration of processing data). Although not included in the illustrated example, in some aspects, the scale 180 and/or intermediate segment 145 may be stored or buffered in a buffer or cache (e.g., on-die memory) prior to being accessed by the processor 115B. For example, in some aspects, the scale 180 and/or intermediate segment 145 may be buffered until all input segments 110 of the feature tensor have been processed (or until one or both buffers are full), allowing the processor 115B to operate on the entire feature tensor (or at least a portion of the feature tensor comprising multiple input segments 110) in parallel.

In the illustrated example, the processor 115B comprises an elementwise-processing module 140B and a post-processing module 150B. Although not depicted in the illustrated example, the processor 115B may include further modules such as a pre-processing module (e.g., the pre-processing module 120 of the processor 115A), a matrix datapath (e.g., a MAC), and the like. Further, although not depicted in the illustrated example, in some aspects, the processor 115B may include one or more control modules which control the flow of data through the processor 115B and/or control which operations are performed by each module, as discussed above.

In the illustrated architecture 100, the scale 180 and intermediate segment 145 are accessed by the elementwise-processing module 140B to generate a normalized segment 185. For example, in some aspects, the elementwise-processing module 140B may perform an elementwise multiplication operation to multiply each element of the intermediate segment 145 by the scale 180. That is, if the intermediate segment 145 is a tensor s_{0:I} having elements [0:I] and the scale 180 is scale, the value of each element of the normalized segment 185 may be defined as (sᵢ*scale) for all i in [0:I].

The normalized segment 185 represents the result of applying a layer normalization operation to the input segment 110. In some aspects, the normalized segment 185 is provided as output of the processor 115B (e.g., to off-die memory, such as the memory 105 or a memory 195). In some aspects, by stacking or concatenating the normalized segments 185 appropriately (e.g., based on how the input segments 110 are sliced from the feature tensor), the resulting output may be the result of applying the layer normalization operation to the feature tensor.

In some aspects, the normalized segment 185 is accessed by the post-processing module 150B. The post-processing module 150B may process the normalized segment 185 for one or more input segments 110 to generate a normalized output 190 (referred to in some aspects as a normalized output tensor). For example, as discussed above, the post-processing module 150B may stack or concatenate the normalized segments 185 to generate the normalized output 190 for the feature tensor. In some aspects, the post-processing module 150B may additionally or alternatively perform other operations, such as a batch normalization operation. For example, the post-processing module 150B may use (learned) mean and standard deviation parameters to perform batch normalization on the normalized segments 185 in order to generate the normalized output 190. In some aspects, the layer normalization is defined as including this final batch normalization. In other aspects, the layer normalization operation may conclude with generation of the normalized segment 185, and the batch normalization operation may optionally be performed on the layer normalized data.

As illustrated, the processor 115B thereby generates and outputs the normalized output 190 (e.g., the feature tensor used to generate the input segments 110, with layer normalization and/or batch normalization applied). As illustrated, the normalized output 190 is provided to an off-die memory 195. The normalized output 190 may then be accessed and used by one or more further operations (e.g., for a next layer or operation of the machine learning model).

As discussed above, by using the techniques and architecture 100, performance of the normalization operation (e.g., layer normalization) can be substantially improved. For example, the normalization operation may consume fewer computational resources (e.g., fewer compute cycles, fewer memory accesses, reduced memory footprint, and the like). As discussed above, such normalization operations are exceedingly common in a variety of machine learning models, such as in neural networks, transformer-based models, and the like. Accordingly, aspects of the present disclosure can substantially reduce the latency and expense of both training and inferencing using such models.

### Example Workflows for Pipelined Normalization for Machine Learning

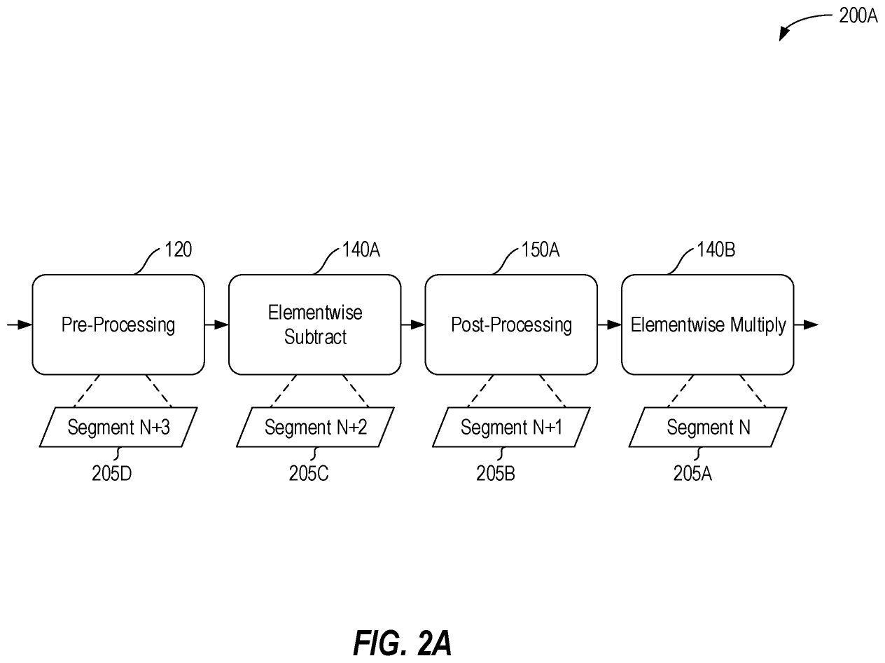

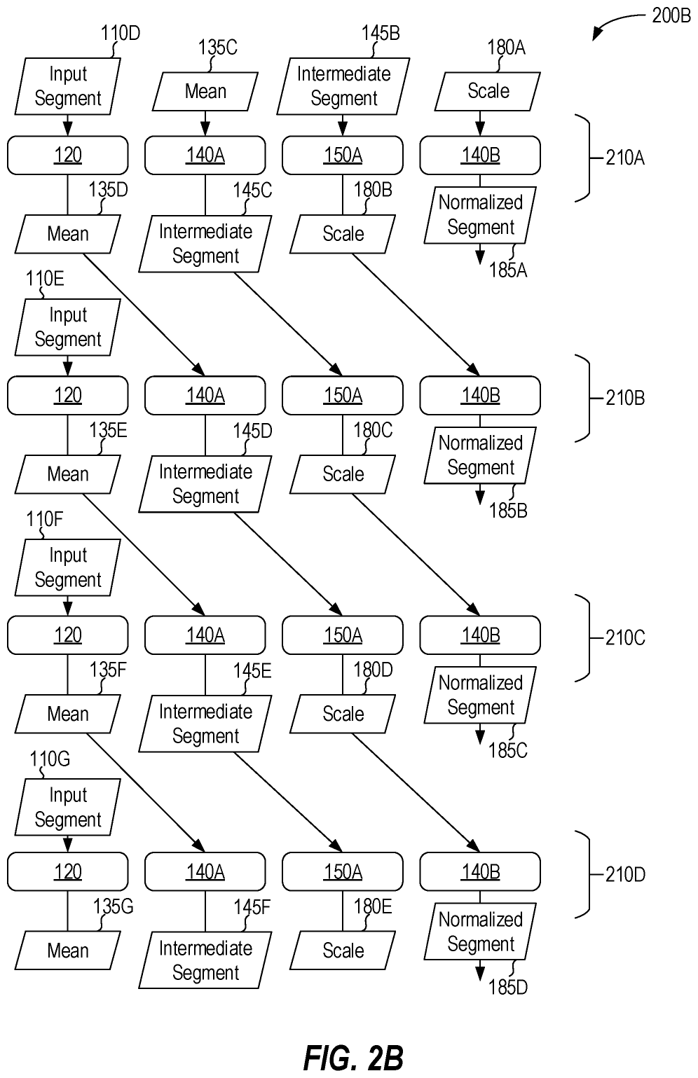

FIGS. 2A and 2B depict example workflows 200A and 200B for pipelined normalization for machine learning, according to some aspects of the present disclosure. In some aspects, the workflows 200A and 200B are performed by a computing system, such as the computing system discussed above with reference to FIG. 1. For example, the workflows 200A and 200B may use the architecture 100 of FIG. 1.

Turning to FIG. 2A, the workflow 200A depicts pipelining four segments of an input tensor (e.g., a feature tensor, as discussed above) for normalization operations (e.g., layer normalization) using a processor unit (e.g., the processor 115 of FIG. 1). Specifically, as illustrated, a first segment 205A labeled “Segment N” (which may correspond to the input segment 110 of FIG. 1) is being processed using the elementwise-processing module 140B (e.g., to apply a generated scale value to the intermediate tensor, as discussed above). For example, as discussed above, the elementwise-processing module 140B may perform scalar multiplication between a scale value for the segment 205A (e.g., the scale 180 of FIG. 1), which may have been generated by the post-processing module 150A during a prior cycle, and the difference between the segment 205A and its mean value (e.g., the intermediate segment 145 of FIG. 1).

Further, as illustrated, the post-processing module 150A may process the segment 205B (labeled “Segment N+1”) during the same cycle. For example, the post-processing module 150A may evaluate the intermediate segment 145 that corresponds to the segment 205B in order to generate a scale value for the segment 205B, as discussed above. As illustrated, this scale generation for the segment 205B may be performed in the same cycle or iteration as the scaling performed by the elementwise-processing module 140B for the segment 205A.

Further, as illustrated, the segment 205C (labeled “Segment N+2”) is being processed by the elementwise-processing module 140A to perform scalar subtraction, as discussed above. For example, in the same cycle or iteration that the post-processing module 150A and the elementwise-processing module 140B are operating on the segments 205B and 205A, respectively, the elementwise-processing module 140A may subtract the mean (e.g., the mean 135) of the segment 205C from each element of the segment 205C in order to generate the intermediate segment 145 for the segment 205C.

Additionally, as illustrated, the segment 205D (labeled “Segment N+3”) may be processed by the pre-processing module 120 to compute the mean 135 of the segment 205D, as discussed above. That is, in the same cycle or iteration that the elementwise-processing module 140A, the post-processing module 150A, and the elementwise-processing module 140B are operating on the segments 205C, 205B, and 205A, respectively, the pre-processing module 120 may compute the mean of the segment 205D.

As discussed above, each cycle or iteration, the segments 205 may move forward one step in the workflow 200A. Specifically, at the cycle immediately prior to the one depicted in FIG. 2A, the pre-processing module 120 was operating on the segment 205C, the elementwise-processing module 140A was operating on the segment 205B, and the post-processing module 150A was operating on the segment 205A. Further, during the cycle immediately subsequent to the one depicted in FIG. 2A, the elementwise-processing module 140A will operate on the segment 205D, the post-processing module 150A will operate on the segment 205C, and the elementwise-processing module 140B will operate on the segment 205B.

As discussed above, this pipelining of segments in the processor 115 enables substantially reduced latency and memory accesses (e.g., because the intermediate data such as the mean, the intermediate segment, and the scale may be stored in on-die memory, rather than off-die memory).

Although the illustrated example depicts four segments 205 being operated on in parallel, in some aspects, the architecture may operate on fewer than four segments 205 at a time. For example, in some aspects, the normalization scale factors (generated by the post-processing module 150A) may be buffered or stored in on-die memory until all segments of the input tensor have been processed to generate a respective scale value for each respective segment (or until the buffer is full, as discussed above). Then, some or all of the segments may be processed (e.g., by the elementwise-processing module 140B) in parallel to generate normalized segments (e.g., to normalize the entire input tensor at once). In some aspects, therefore, the computing system may operate on three segments in parallel.

Specifically, the pre-processing module 120 of the processor 115 may operate on one segment 205D while the elementwise-processing module 140A of the processor 115 operates on another segment 205C and the post-processing module 150A of the processor 115 operates on a third segment 205B. The post-processing module 150A may store the scale factors in a buffer. In some aspects, the intermediate segments (generated by the elementwise module 140A) may similarly be stored in a buffer or other on-die memory. In some aspects, the scale and intermediate segments may be stored in an off-die memory or buffer. Once the buffer(s) are full (or all segments have been processed), the computing system may use the same processor 115 to apply the scale values, as discussed above.

Further, in some aspects, the workflow 200A may additionally include one or more additional operations, such as application of a batch normalization operation (e.g., by the post-processing module 150B of FIG. 1) to the normalized segments.

Turning to FIG. 2B, a workflow 200B for pipelining segments is depicted. In the workflow 200B, each computing iteration is depicted by a discrete cycle 210A-D. That is, the cycle 210A may be performed prior to the cycle 210B, the cycle 210B is performed prior to the cycle 210C, and the cycle 210C is performed prior to the cycle 210D.

As illustrated, during the first cycle 210A, an input segment 110D is accessed by the pre-processing module 120 to generate a corresponding mean 135D. Further, during the first cycle 210A, a mean 135C for a second segment is processed by the elementwise-processing module 140A to generate a corresponding intermediate segment 145C, as discussed above. Additionally, during the first cycle 210A, the post-processing module 150A accesses an intermediate segment 145B for a third segment to generate a corresponding scale 180B. Moreover, during the first cycle 210A, the elementwise-processing module 140B operates on a scale 180A for a fourth segment to generate a normalized segment 185A for the fourth segment.

In the illustrated workflow 200B, each segment then moves one step or operation forward in the pipeline. Specifically, during the second cycle 210B, a new input segment 110E is accessed by the pre-processing module 120 to generate a corresponding mean 135E. Further, during the second cycle 210B, the mean 135D for the input segment 110D (generated during the prior cycle 210A) is processed by the elementwise-processing module 140A to generate a corresponding intermediate segment 145D, as discussed above. Additionally, during the second cycle 210B, the post-processing module 150A accesses the intermediate segment 145C (generated during the prior cycle 210A) for the second segment to generate a corresponding scale 180C. Moreover, during the second cycle 210B, the elementwise-processing module 140B operates on the scale 180B (generated during the prior cycle 210A) for the third segment to generate a normalized segment 185B for the third segment.

As discussed above, each segment then moves one step or operation forward in the pipeline. Specifically, during the third cycle 210C, a new input segment 110F is accessed by the pre-processing module 120 to generate a corresponding mean 135F. Further, during the third cycle 210C, the mean 135E for the input segment 110E (generated during the prior cycle 210B) is processed by the elementwise-processing module 140A to generate a corresponding intermediate segment 145E, as discussed above. Additionally, during the third cycle 210C, the post-processing module 150A accesses the intermediate segment 145D (generated during the prior cycle 210B) for the input segment 110D to generate a corresponding scale 180D. Moreover, during the third cycle 210C, the elementwise-processing module 140B operates on the scale 180C (generated during the prior cycle 210B) for the second segment to generate a normalized segment 185C for the second segment.

As illustrated, each segment then moves one step or operation forward in the pipeline. Specifically, during the fourth cycle 210D, a new input segment 110G is accessed by the pre-processing module 120 to generate a corresponding mean 135G. Further, during the fourth cycle 210D, the mean 135F for the input segment 110F (generated during the prior cycle 210C) is processed by the elementwise-processing module 140A to generate a corresponding intermediate segment 145F, as discussed above. Additionally, during the fourth cycle 210D, the post-processing module 150A accesses the intermediate segment 145E (generated during the prior cycle 210C) for the input segment 110E to generate a corresponding scale 180E. Moreover, during the fourth cycle 210D, the elementwise-processing module 140B operates on the scale 180D (generated during the prior cycle 210C) for the input segment 110D to generate a normalized segment 185D for the input segment 110D.

In this way, the architecture can efficiently pipeline operations to substantially reduce latency and computational expense of the normalization operation.

As discussed above, although the illustrated example depicts four segments being operated on in parallel, in some aspects, the architecture may operate on fewer than four segments at a time. For example, in some aspects, the scales 180 (generated by the post-processing module 150A) may be buffered or stored in on-die memory until all segments of the input tensor have been processed to generate a respective scale value for each respective segment (or until the buffer is full, as discussed above). Then, some or all of the segments may be processed (e.g., by the elementwise-processing module 140B) in parallel to generate normalized segments (e.g., to normalize the entire input tensor at once). In some aspects, therefore, the computing system may operate on three segments in parallel.

Specifically, the post-processing module 150A may store the scales 180B, 180C, 180D, and 180E (and so on for each input segment) in a buffer. In some aspects, the intermediate segments 145 (generated by the elementwise module 140A) may similarly be stored in a buffer or other on-die memory. In some aspects, the scale and intermediate segments may be stored in an off-die memory or buffer. Once the buffer(s) are full (or all segments have been processed), the computing system may use the elementwise-processing module 140B to apply the scale values, as discussed above.

Further, as discussed above, the workflow 200B may additionally include one or more additional operations in some aspects, such as application of a batch normalization operation (e.g., by the post-processing module 150B of FIG. 1) to the normalized segments 185.

### Example Architecture for Improved Data Normalization for Machine Learning

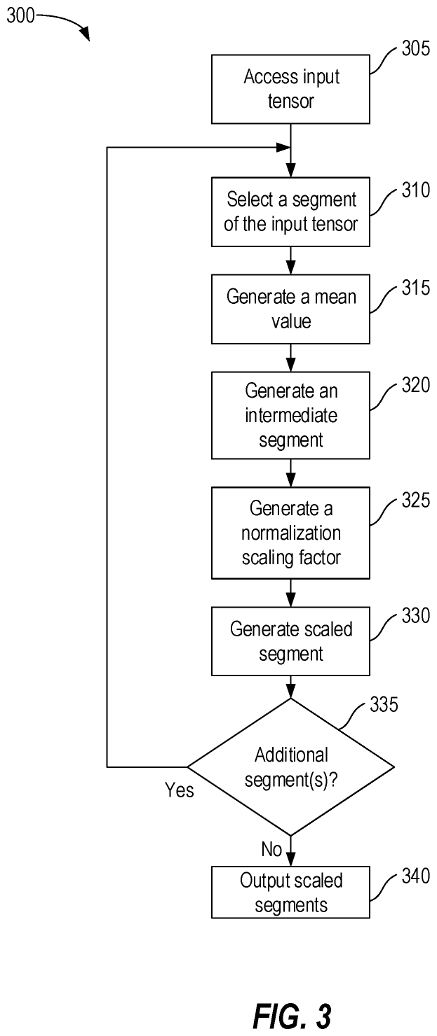

FIG. 3 is a flow diagram depicting an example method 300 for improved data normalization for machine learning, according to some aspects of the present disclosure. In some aspects, the method 300 is performed by a computing system, such as the computing system discussed above with reference to the architecture 100 FIG. 1 and/or the workflows 200A and 200B of FIGS. 2A and 2B.

At block 305, the computing system accesses an input tensor. In some aspects, as discussed above, the input tensor may be generated while processing data using a machine learning model. For example, the input tensor may be a feature map, an activation tensor, and the like. Generally, the input tensor may correspond to any tensor generated while processing input data using the machine learning model.

At block 310, the computing system selects a segment of the input tensor (e.g., the input segment 110 of FIGS. 1 and 2B and/or the segments 205 of FIG. 2. In some aspects, the segments of the input tensor are defined based on the normalization operation being applied. For example, for a layer normalization operation, the segments may correspond to rows, columns, or other slices of the input tensor. Generally, the computing system may select the segments using any order and technique, as all segments will be processed during the method 300. For example, the computing system may select the segments sequentially (e.g., based on the row indices), or may select the segments randomly or pseudo-randomly (or according to any other criteria).

At block 315, the computing system generates a mean value (e.g., the mean 135 of FIG. 1) for the selected segment. In some aspects, as discussed above, the mean value of the segment is defined as the mean or average value of all the elements in the segment. In some aspects, as discussed above, the computing system uses a pre-processing module (e.g., the pre-processing module 120 of FIG. 1) to generate the mean. For example, the computing system may sum the elements of the selected segment, and then multiply the sum by the reciprocal of the size of the segment.

At block 320, the computing system generates an intermediate segment (e.g., the intermediate segment 145 of FIG. 1) for the selected segment based on the mean. In some aspects, as discussed above, the intermediate segment is defined as the elementwise subtraction between the selected segment and the generated mean (e.g., subtracting the mean from each element of the segment). In some aspects, as discussed above, the computing system uses an elementwise-processing module (e.g., the elementwise-processing module 140A of FIG. 1) to perform this subtraction.

At block 325, the computing system generates a normalization scaling factor (e.g., the scale 180 of FIG. 1) for the selected segment based on the intermediate segment.

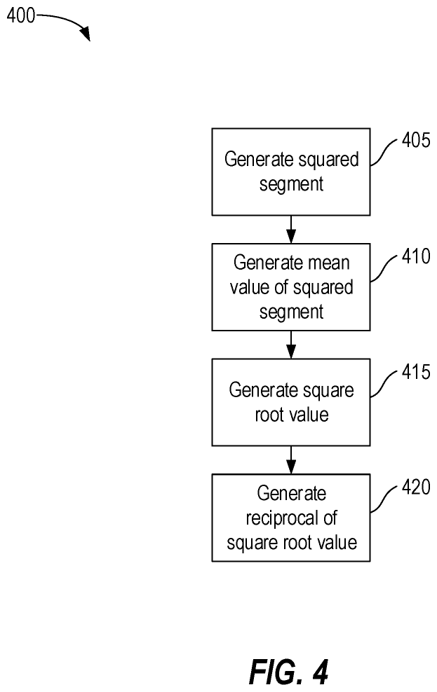

In some aspects, as discussed above, the scale is generated by squaring each element of the intermediate segment to generate a squared segment, computing the mean value of the elements in the squared segment, taking the square root value of the mean value of the squared segment, and finding the reciprocal of the square root value. In some aspects, as discussed above, the computing system uses a post-processing module (e.g., the post-processing 150A of FIG. 1) to perform this operation. One example method for generating the normalization scaling factor is discussed in more detail below with reference to FIG. 4.

At block 330, the post-processing generates a scaled segment (e.g., the normalized segment 185 of FIG. 1) based on the normalization scaling factor for the selected segment. In some aspects, as discussed above, the scaled segment is defined as the elementwise product (e.g., the scalar product) between the intermediate segment (generated at block 320) and the normalization scaling factor (generated at block 325). In some aspects, as discussed above, the computing system uses an elementwise-processing module (e.g., the elementwise-processing module 140B of FIG. 1) to perform this multiplication.

At block 335, the computing system determines whether there is at least one additional segment remaining in the input tensor. If so, the method 300 returns to block 310 to select the next segment. If not, the method 300 continues to block 340. Although a sequential process is depicted for conceptual clarity (e.g., selecting and processing each segment iteratively), in some aspects, the computing system may process some or all of the segments in parallel. For example, as discussed above, the computing system may pipeline the segments (e.g., performing blocks 315, 320, 325, and/or 330 for different segments in parallel each cycle).

Further, in some aspects, the computing system may perform block 330 subsequent to completing blocks 315, 320, and 325 for each segment. For example, as discussed above, the computing system may buffer or store the normalization scale factors and/or the intermediate segments for each input segment until either (i) all segments in the input tensor have been processed, or (ii) the buffer or storage is full. The computing system may then perform block 330 for some or all of the segments in parallel, as discussed above.

At block 340, the computing system outputs the scaled segments (e.g., the normalized output 190). In some aspects, as discussed above, the computing system may stack or concatenate the scaled segments according to how the segments are arranged in the input tensor (e.g., stacking the rows or columns). In some aspects, as discussed above, the computing system may optionally perform additional operations, such as applying a batch normalization operation to the scaled segments.

### Example Method for Efficient Normalization Scaling Factor Generation for Improved Normalization for Machine Learning

FIG. 4 is a flow diagram depicting an example method 400 for efficient normalization scaling factor generation for improved normalization for machine learning, according to some aspects of the present disclosure. In some aspects, the method 400 is performed by a computing system, such as the computing system discussed above with reference to the architecture 100 of FIG. 1, the workflows 200A and 200B of FIGS. 2A and 2B, and/or the method 300 of FIG. 3. In some aspects, the method 400 provides additional detail for block 325 of FIG. 3 (generating the normalization scale factor). In some aspects, the method 400 is performed using a post-processing module of a processor unit (e.g., the post-processing module 150A of the processor 115, each depicted in FIG. 1).

At block 405, the computing system generates a squared segment based on the intermediate segment (e.g., intermediate segment 145 of FIG. 1) corresponding to the input segment that is currently being processed. For example, as discussed above, the computing system may use a squaring operation (e.g., the square operation 155 of FIG. 1) to compute the square of each element in the intermediate tensor.

At block 410, the computing system generates a mean value of the squared segment. For example, as discussed above, the computing system may use a sum operation (e.g., the sum operation 160 of FIG. 1) to generate a sum of the elements of the squared tensor, followed by a mean operation (e.g., the mean operation 165 of FIG. 1) to multiply the sum by the reciprocal of the size of the squared segment (or, equivalently, to divide the sum by the size of the squared segment).

At block 415, the computing system generates a square root value of the mean value of the squared segment. For example, as discussed above, the computing system may use a square root operation (e.g., the square root operation 170 of FIG. 1) to generate the square root of the mean value of the squared segment.

At block 420, the computing system generates the reciprocal of the square root value. For example, as discussed above, the computing system may use a reciprocal operation (e.g., the reciprocal operation 175 of FIG. 1) to generate the reciprocal. In some aspects, as discussed above, this reciprocal value is the normalization scaling factor for the selected input segment.

### Example Method for Normalization Operations in Machine Learning Models

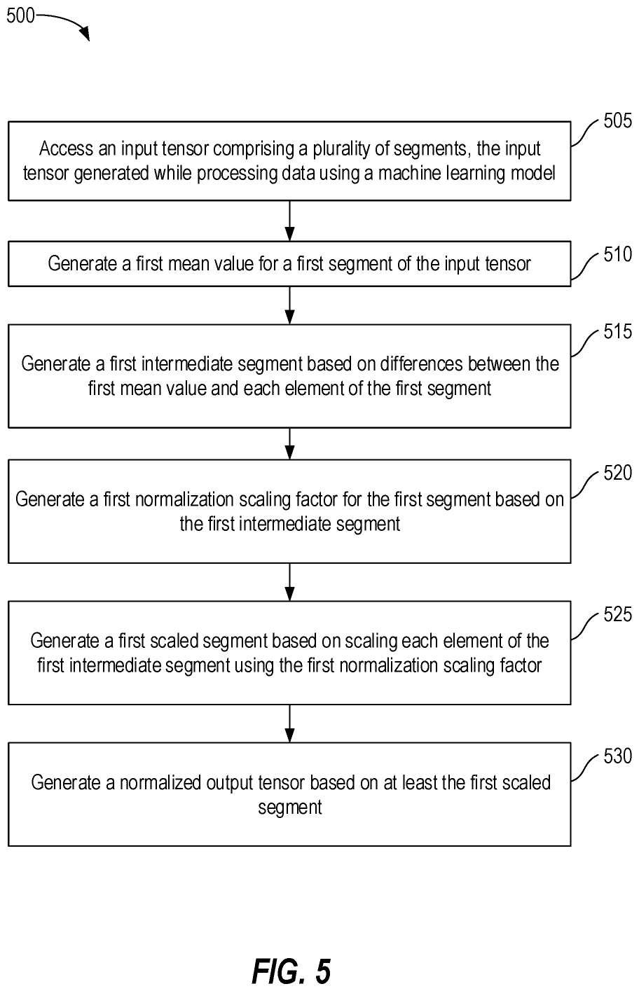

FIG. 5 is a flow diagram depicting an example method 500 for normalization operations in machine learning models, according to some aspects of the present disclosure. In some aspects, the method 500 is performed by a computing system, such as the computing system discussed above with reference to the architecture 100 of FIG. 1, the workflows 200A and 200B of FIGS. 2A and 2B, the method 300 of FIG. 3, and/or the method 400 of FIG. 4. In some aspects, the method 500 is performed using a processor.

At block 505, an input tensor comprising a plurality of segments is accessed, the input tensor generated while processing data using a machine learning model.

At block 510, a first mean value is generated for a first segment of the input tensor.

At block 515, a first intermediate segment is generated based on differences between the first mean value and each element of the first segment.

At block 520, a first normalization scaling factor is generated for the first segment based on the first intermediate segment.

At block 525, a first scaled segment is generated based on scaling each element of the first intermediate segment using the first normalization scaling factor.

At block 530, a normalized output tensor is generated based on at least the first scaled segment.

In some aspects, the processor comprises an on-die memory on a same die as the processor, the input tensor is accessed from an off-die memory, and generating the first mean value, the first intermediate segment, and the first normalization scaling factor are performed using the on-die memory without the processor accessing the off-die memory.

In some aspects, the method 500 further includes outputting the normalized output tensor to the off-die memory.

In some aspects, the method 500 implements a normalization operation applied while processing the data using a transformer of the machine learning model.

In some aspects, generating the first normalization scaling factor comprises: generating a squared segment based on squaring each element of the first intermediate segment, generating a second mean value for the squared segment, generating a square root value of the second mean value, and generating the first normalization scaling factor as a reciprocal of the square root value.

In some aspects, scaling each element of the first intermediate segment comprises multiplying each element of the first intermediate segment by the first normalization scaling factor.

In some aspects, the method 500 further includes generating a second mean value for a second segment of the input tensor, generating a second intermediate segment based on differences between the second mean value and each element of the second segment, generating a second normalization scaling factor for the second segment based on the second intermediate segment, and generating a second scaled segment, for the normalized output tensor, based on scaling each element of the second intermediate segment using the second normalization scaling factor.

In some aspects, the method further comprises pipelining the plurality of segments, wherein: both the first intermediate segment and the second mean value are generated during a first compute cycle of the processor, and both the first normalization scaling value and the second intermediate segment are generated during a second compute cycle of the processor subsequent to the first compute cycle.

In some aspects, the method 500 further includes generating a third normalization scaling factor for a third segment of the input tensor during the first compute cycle.

In some aspects, generating the first scaled segment comprises: storing the first intermediate segment and the first normalization scaling factor in one or more buffers, and generating the first scaled segment in response to determining that either (i) at least one of the one or more buffers is full, or (ii) no additional elements remain in the first segment.

In some aspects, generating the first mean value is performed using a pre-processing module of the processor, generating the first intermediate segment is performed using a first elementwise-processing module of the processor, generating the first normalization scaling factor is performed using a post-processing module of the processor, and generating of the first scaled segment is performed using a second elementwise-processing module of the processor.

### Example Processing System for Machine Learning

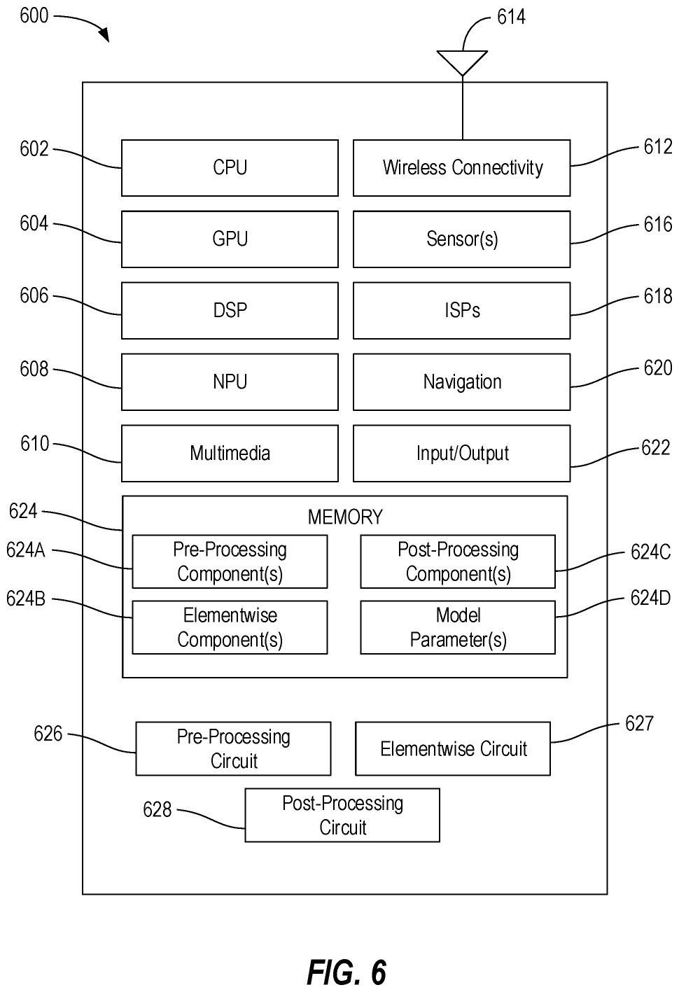

FIG. 6 depicts an example processing system 600 configured to perform various aspects of the present disclosure, including, for example, the techniques and methods described with respect to FIGS. 1, 2A-2B, 3, 4, and/or 5. In some aspects, the processing system 600 may correspond to a computing system. For example, the processing system 600 may correspond to the computing system discussed above with reference to FIGS. 1, 2A-2B, 3, 4, and/or 5. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a pre-processing component 624A, an elementwise component 624B, and a post-processing component 624C. Although not depicted in the illustrated example, the memory 624 may also include other components, such as an inferencing component to manage the generation of output predictions using trained machine learning models, a training component used to train or update the machine learning model(s), components to perform other machine learning operations such as convolution, and the like. Though depicted as discrete components for conceptual clarity in FIG. 6, the illustrated components (and others not depicted) may be collectively or individually implemented in various aspects.

As illustrated, the memory 624 also includes a set of model parameters 624D (e.g., parameters of one or more machine learning models or components thereof). For example, the model parameters 624D may include parameters for an artificial neural network, such as a network having one or more transformers for self-attention. Although not depicted in the illustrated example, the memory 624 may also include other data such as training data for the machine learning model(s).

The processing system 600 further comprises a pre-processing circuit 626, an elementwise circuit 627, and a post-processing circuit 628. The depicted circuits, and others not depicted (such as an inferencing circuit), may be configured to perform various aspects of the techniques described herein.

The pre-processing component 624A and/or the pre-processing circuit 626 (which may correspond to the pre-processing module 120 of FIG. 1) may be used to perform various pre-processing operations to facilitate normalization operations, as discussed above. For example, the pre-processing component 624A and/or the pre-processing circuit 626 may evaluate tensor segments (e.g., the input segment 110 of FIG. 1) to generate a respective mean value (e.g., the mean 135 of FIG. 1) for each tensor segment.

The elementwise component 624B and/or the elementwise circuit 627 (which may correspond to the elementwise-processing module 140A and/or 140B of FIG. 1) may be used to perform various elementwise operations to facilitate normalization operations, as discussed above. For example, the elementwise component 624B and/or the elementwise circuit 627 may subtract the mean of a tensor segment from each element in the segment to generate an intermediate segment (e.g., the intermediate segment 145 of FIG. 1). As another example, the elementwise component 624B and/or elementwise circuit 627 may multiply each element in the intermediate segment by the generated normalization scaling factor (e.g., the scale 180 of FIG. 1) for the segment to generate a normalized segment (e.g., the normalized segment 185 of FIG. 1).

The post-processing component 624C and/or the post-processing circuit 628 (which may correspond to the post-processing module 150A and/or 150B of FIG. 1) may be used to perform various post-processing operations to facilitate normalization operations, as discussed above. For example, the post-processing component 624C and/or the post-processing circuit 628 may evaluate the intermediate segments to generate normalization scaling factors (e.g., the scale 180 of FIG. 1). As another example, the post-processing component 624C and/or the post-processing circuit 628 may aggregate and/or process normalized segments to generate normalized output (e.g., normalized output 190 of FIG. 1), such as by stacking or concatenating the normalized segments, applying batch normalization operations to the normalized segments, and the like.

Though depicted as separate components and circuits for clarity in FIG. 6, the pre-processing circuit 626, the elementwise circuit 627, and the post-processing circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:
Clause 1: A method for machine learning using a processor, comprising: accessing an input tensor comprising a plurality of segments, the input tensor generated while processing data using a machine learning model; and applying a normalization operation of the machine learning model to the input tensor, comprising: generating a first mean value for a first segment of the input tensor; generating a first intermediate segment based on differences between the first mean value and each element of the first segment; generating a first normalization scaling factor for the first segment based on the first intermediate segment; generating a first scaled segment based on scaling each element of the first intermediate segment using the first normalization scaling factor; and generating a normalized output tensor based on at least the first scaled segment.
Clause 2: A method according to Clause 1, wherein: the processor comprises an on-die memory on a same die as the processor; the input tensor is accessed from an off-die memory; and generating the first mean value, the first intermediate segment, and the first normalization scaling factor are performed using the on-die memory without the processor accessing the off-die memory.
Clause 3: A method according to Clause 2, further comprising outputting the normalized output tensor to the off-die memory.
Clause 4: A method according to any of Clauses 1-3, wherein the normalization operation is applied while processing the data using a transformer of the machine learning model.
Clause 5: A method according to any of Clauses 1-4, wherein generating the first normalization scaling factor comprises: generating a squared segment based on squaring each element of the first intermediate segment; generating a second mean value for the squared segment; generating a square root value of the second mean value; and generating the first normalization scaling factor as a reciprocal of the square root value.
Clause 6: A method according to any of Clauses 1-5, wherein scaling each element of the first intermediate segment comprises multiplying each element of the first intermediate segment by the first normalization scaling factor.
Clause 7: A method according to any of Clauses 1-6, wherein applying the normalization operation to the input tensor further comprises: generating a second mean value for a second segment of the input tensor; generating a second intermediate segment based on differences between the second mean value and each element of the second segment; generating a second normalization scaling factor for the second segment based on the second intermediate segment; and generating a second scaled segment, for the normalized output tensor, based on scaling each element of the second intermediate segment using the second normalization scaling factor.
Clause 8: A method according to Clause 7, wherein the method further comprises pipelining the plurality of segments, wherein: both the first intermediate segment and the second mean value are generated during a first compute cycle of the processor; and both the first normalization scaling value and the second intermediate segment are generated during a second compute cycle of the processor subsequent to the first compute cycle.
Clause 9: A method according to Clause 8, further comprising generating a third normalization scaling factor for a third segment of the input tensor during the first compute cycle.
Clause 10: A method according to any of Clauses 1-9, wherein generating the first scaled segment comprises: storing the first intermediate segment and the first normalization scaling factor in one or more buffers; and generating the first scaled segment in response to determining that either (i) at least one of the one or more buffers is full, or (ii) no additional elements remain in the first segment.
Clause 11: A method according to any of Clauses 1-10, wherein: generating the first mean value is performed using a pre-processing module of the processor; generating the first intermediate segment is performed using a first elementwise-processing module of the processor; generating the first normalization scaling factor is performed using a post-processing module of the processor; and generating of the first scaled segment is performed using a second elementwise-processing module of the processor.
Clause 12: A processing system comprising: a memory comprising computer-executable instructions; and one or more processors configured to execute the computer-executable instructions and cause the processing system to perform a method in accordance with any of Clauses 1-11.
Clause 13: A processing system comprising means for performing a method in accordance with any of Clauses 1-11.
Clause 14: A non-transitory computer-readable medium comprising computer-executable instructions that, when executed by one or more processors of a processing system, cause the processing system to perform a method in accordance with any of Clauses 1-11.
Clause 15: A computer program product embodied on a computer-readable storage medium comprising code for performing a method in accordance with any of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access an input tensor comprising a plurality of segments, the input tensor generated while processing data using a machine learning model; and
apply a normalization operation of the machine learning model to the input tensor, wherein, to apply the normalization operation, the one or more processors are configured to execute the processor-executable instructions and cause the processing system to:
generate a first mean value for a first segment of the input tensor;
generate a first intermediate segment based on differences between the first mean value and each element of the first segment;
generate a first normalization scaling factor for the first segment based on the first intermediate segment;
generate a first scaled segment based on scaling each element of the first intermediate segment using the first normalization scaling factor; and
generate a normalized output tensor based on at least the first scaled segment.

2. The processing system of claim 1, wherein:
the one or more processors comprise one or more on-die memories on a same die as the one or more processors;
the input tensor is accessed from an off-die memory; and
to generate the first mean value, the first intermediate segment, and the first normalization scaling factor, the one or more processors are configured to execute the processor-executable instructions and cause the processing system to generate the first mean value, the first intermediate segment, and the first normalization scaling factor using the on-die memory without the one or more processors accessing the off-die memory.

3. The processing system of claim 2, wherein the one or more processors are configured to further execute the processor-executable instructions and cause the processing system to output the normalized output tensor to the off-die memory.

4. The processing system of claim 1, wherein the normalization operation is part of a transformer of the machine learning model.

5. The processing system of claim 1, wherein, to generate the first normalization scaling factor, the one or more processors are configured to further execute the processor-executable instructions and cause the processing system to:
generate a squared segment based on squaring each element of the first intermediate segment;
generate a second mean value for the squared segment;
generate a square root value of the second mean value; and
generate the first normalization scaling factor as a reciprocal of the square root value.

6. The processing system of claim 1, wherein, to scale each element of the first intermediate segment, the one or more processors are configured to further execute the processor-executable instructions and cause the processing system to multiply each element of the first intermediate segment by the first normalization scaling factor.

7. The processing system of claim 1, wherein, to apply the normalization operation to the input tensor, the one or more processors are configured to further execute the processor-executable instructions and cause the processing system to:
generate a second mean value for a second segment of the input tensor;
generate a second intermediate segment based on differences between the second mean value and each element of the second segment;
generate a second normalization scaling factor for the second segment based on the second intermediate segment; and
generate a second scaled segment, for the normalized output tensor, based on scaling each element of the second intermediate segment using the second normalization scaling factor.

8. The processing system of claim 7, wherein the one or more processors are configured to further execute the processor-executable instructions and cause the processing system to pipeline the plurality of segments, wherein:
both the first intermediate segment and the second mean value are generated during a first compute cycle of the one or more processors; and
both the first normalization scaling factor and the second intermediate segment are generated during a second compute cycle of the one or more processors subsequent to the first compute cycle.

9. The processing system of claim 8, wherein the one or more processors are configured to further execute the processor-executable instructions and cause the processing system to generate a third normalization scaling factor for a third segment of the input tensor during the first compute cycle.

10. The processing system of claim 1, wherein, to generate the first scaled segment, the one or more processors are configured to further execute the processor-executable instructions and cause the processing system to:
store the first intermediate segment and the first normalization scaling factor in one or more buffers; and
generate the first scaled segment in response to determining that either (i) at least one of the one or more buffers is full, or (ii) no additional elements remain in the first segment.

11. The processing system of claim 1, wherein to generate the first mean value, the first intermediate segment, and the first normalization scaling factor, and the first scaled segment, the one or more processors are configured to execute the processor-executable instructions and cause the processing system to:
generate the first mean value using one or more pre-processing modules of the one or more processors;
generate the first intermediate segment using one or more first elementwise-processing modules of the one or more processors;
generate the first normalization scaling factor using one or more post-processing modules of the one or more processors; and
generate the first scaled segment using one or more second elementwise-processing modules of the one or more processors.

12. A method for machine learning using a processor, comprising:
accessing an input tensor comprising a plurality of segments, the input tensor generated while processing data using a machine learning model; and
applying a normalization operation of the machine learning model to the input tensor, comprising:
generating a first mean value for a first segment of the input tensor;
generating a first intermediate segment based on differences between the first mean value and each element of the first segment;
generating a first normalization scaling factor for the first segment based on the first intermediate segment;
generating a first scaled segment based on scaling each element of the first intermediate segment using the first normalization scaling factor; and
generating a normalized output tensor based on at least the first scaled segment.

13. The method of claim 12, wherein:
the processor comprises an on-die memory on a same die as the processor;
the input tensor is accessed from an off-die memory; and
generating the first mean value, the first intermediate segment, and the first normalization scaling factor are performed using the on-die memory without the processor accessing the off-die memory.

14. The method of claim 13, further comprising outputting the normalized output tensor to the off-die memory.

15. The method of claim 12, wherein generating the first normalization scaling factor comprises:
generating a squared segment based on squaring each element of the first intermediate segment;
generating a second mean value for the squared segment;
generating a square root value of the second mean value; and
generating the first normalization scaling factor as a reciprocal of the square root value.

16. The method of claim 12, wherein applying the normalization operation to the input tensor further comprises:
generating a second mean value for a second segment of the input tensor;
generating a second intermediate segment based on differences between the second mean value and each element of the second segment;
generating a second normalization scaling factor for the second segment based on the second intermediate segment; and
generating a second scaled segment, for the normalized output tensor, based on scaling each element of the second intermediate segment using the second normalization scaling factor.

17. The method of claim 16, wherein the method further comprises pipelining the plurality of segments, wherein:
both the first intermediate segment and the second mean value are generated during a first compute cycle of the processor; and
both the first normalization scaling factor and the second intermediate segment are generated during a second compute cycle of the processor subsequent to the first compute cycle.

18. The method of claim 17, further comprising generating a third normalization scaling factor for a third segment of the input tensor during the first compute cycle.

19. The method of claim 12, wherein generating the first scaled segment comprises:
storing the first intermediate segment and the first normalization scaling factor in one or more buffers; and
generating the first scaled segment in response to determining that either (i) at least one of the one or more buffers is full, or (ii) no additional elements remain in the first segment.

20. The method of claim 12, wherein:
generating the first mean value is performed using a pre-processing module of the processor;
generating the first intermediate segment is performed using a first elementwise-processing module of the processor;
generating the first normalization scaling factor is performed using a post-processing module of the processor; and
generating of the first scaled segment is performed using a second elementwise-processing module of the processor.
